(19) United States
(12) Patent Application Publication
(10) Pub. No.: US 2026/0301218 A1
(43) Pub. Date: Oct. 1, 2026

(54) METHOD AND APPARATUS FOR EVALUATING ASSEMBLY POSE OF INDUSTRIAL PART, MEDIUM, AND PRODUCT

(71) Applicant: Taizhou University, Taizhou City (CN)

(72) Inventors: Xuan ZHENG, Taizhou City (CN); Pengzhan CHEN, Taizhou City (CN); Zhixiong WU, Taizhou City (CN); Yong GUAN, Taizhou City (CN); Feiyang CHEN, Taizhou City (CN); Liming LAO, Taizhou City (CN); Yongchao ZHANG, Taizhou City (CN)

(21) Appl. No.: 19/575,401

(22) Filed: Mar. 23, 2026

(30) Foreign Application Priority Data
Mar. 25, 2025 (CN) 202510360758.4

(51) Int. Cl. G06T 7/73

(52) U.S. Cl. CPC G06T 7/73; G06T 2207/10028; G06T 2207/20084; G06T 2207/30108

(57) ABSTRACT

Provided are a method and apparatus for evaluating an assembly pose of an industrial part, a medium, and a product, relating to the field of assembly pose evaluation. The method includes: acquiring image data and geometric information of an industrial part; obtaining visual features and geometric features based on the image data and the geometric information respectively; performing feature fusion on the visual features and the geometric features by using a multi-head self-attention mechanism of a Transformer model to obtain fused features; performing dynamic feature weight allocation on the visual features and the geometric features by using a dynamic feature weight allocation model based on a two-layer fuzzy inference algorithm to obtain feature weights; and determining a pose state of the industrial part by using a pose evaluation model according to the fused features and the feature weights. This application improves pose evaluation accuracy and system adaptability.

### CROSS REFERENCE TO RELATED APPLICATION

This patent application claims the benefit and priority of Chinese Patent Application No. 202510360758.4, filed with the China National Intellectual Property Administration on Mar. 25, 2025, the disclosure of which is incorporated by reference herein in its entirety as part of the present application.

### TECHNICAL FIELD

The present disclosure relates to the field of assembly pose evaluation, and in particular, to a method and apparatus for evaluating an assembly pose of an industrial part, a medium, and a product.

### BACKGROUND

With the development of industrial automated assembly technology, robots play an increasingly important role in part assembly. However, due to factors such as complex shapes of parts, variable environmental conditions, and sensor noise in industrial environments, conventional pose evaluation methods based on geometric features, traditional vision, and traditional machine learning often face the following technical problems:

1. Insufficient pose evaluation accuracy: Affected by different environmental conditions (such as illumination and occlusion) and part characteristics (such as shape and size), traditional methods are difficult to provide high-precision pose evaluation.

2. Poor environmental adaptability: The pose evaluation methods in the prior art usually rely on a single modality (such as only visual or geometric information), resulting in unstable performance in variable environments and poor adaptability to new environments.

3. Ineffective feature fusion: Multi-modal fusion of visual information and geometric information is involved in an assembly process, and how to effectively combine these heterogeneous features to improve evaluation accuracy remains a key problem.

Therefore, in view of the above problems, there is an urgent need to provide a method or system for evaluating an assembly pose of an industrial part, so as to improve the pose evaluation accuracy and system adaptability.

### SUMMARY

An objective of the present disclosure is to provide a method and apparatus for evaluating an assembly pose of an industrial part, a medium, and a product, which can improve pose evaluation accuracy and system adaptability.

To achieve the above objective, the present disclosure provides the following technical solutions.

According to a first aspect, the present disclosure provides a method for evaluating an assembly pose of an industrial part, including:
acquiring image data and geometric information of an industrial part;
obtaining visual features and geometric features based on the image data and the geometric information respectively;
performing feature fusion on the visual features and the geometric features by using a multi-head self-attention mechanism of a Transformer model to obtain fused features;
performing dynamic feature weight allocation on the visual features and the geometric features by using a dynamic feature weight allocation model based on a two-layer fuzzy inference algorithm to obtain feature weights; and
determining a pose state of the industrial part by using a pose evaluation model according to the fused features and the feature weights, where the pose state includes: a position and an orientation of the industrial part.

Optionally, the acquiring the image data and the geometric information of the industrial part specifically includes:
acquiring the image data of the industrial part by using a vision sensor; and
acquiring the geometric information of the industrial part by using a depth sensor.

Optionally, the obtaining the visual features and the geometric features based on the image data and the geometric information respectively specifically includes:
extracting the visual features from the image data by using a convolutional neural network (CNN); and
extracting the geometric features from the geometric information by using a point cloud processing algorithm.

Optionally, the performing dynamic feature weight allocation on the visual features and the geometric features by using the dynamic feature weight allocation model based on the two-layer fuzzy inference algorithm to obtain the feature weights specifically includes:
determining the feature weights by using a formula as follows: α_{final}=λ₁α₁+λ₂α₂;
where α_{final} represents the feature weights; λ₁ and λ₂ are weighting coefficients for characterizing relative importance of the two-layer fuzzy inference algorithm; α₁ represents preliminary weights of the visual features and the geometric features obtained by a first-layer fuzzy inference algorithm; α₁=f₁(E, T); f₁ is a fuzzy inference function based on an environmental condition and a task requirement, E is the environmental condition, and T is the task requirement; α₂ represents weights adjusted by a second-layer fuzzy inference algorithm; α₂=f₂(α₁, F_{feedback}); f₂ is a fuzzy inference function based on real-time feedback, and F_{feedback} is real-time feedback information.

Optionally, the pose evaluation model is a multi-layer perceptron.

Optionally, the determining the pose state of the industrial part by using the pose evaluation model according to the fused features and the feature weights specifically includes:
determining the pose state of the industrial part by using a formula as follows: Pₚₒₛₑ=MLP(F_{fuse}·α_{final});
where Pₚₒₛₑ represents the pose state, MLP represents the multi-layer perceptron, α_{final} represents the feature weights, and F_{fuse} represents the fused features.

According to a second aspect, the present disclosure provides an apparatus for evaluating an assembly pose of an industrial part, including:
a data acquisition module configured to acquire image data and geometric information of an industrial part;
a feature extraction module configured to obtain visual features and geometric features based on the image data and the geometric information respectively;
a multi-modal feature fusion module configured to perform feature fusion on the visual features and the geometric features by using a multi-head self-attention mechanism of a Transformer model to obtain fused features;
a dynamic feature weight allocation module configured to perform dynamic feature weight allocation on the visual features and the geometric features by using a dynamic feature weight allocation model based on a two-layer fuzzy inference algorithm to obtain feature weights; and
a pose evaluation module configured to determine a pose state of the industrial part by using a pose evaluation model according to the fused features and the feature weights, where the pose state includes: a position and an orientation of the industrial part.

According to a third aspect, the present disclosure provides a computer device, including a memory, a processor, and a computer program stored in the memory and executable on the processor, where the processor executes the computer program to implement the method for evaluating an assembly pose of an industrial part.

According to a fourth aspect, the present disclosure provides a computer-readable storage medium storing a computer program, where the computer program, when executed by a processor, implements the method for evaluating an assembly pose of an industrial part.

According to a fifth aspect, the present disclosure provides a computer program product, including a computer program, where the computer program, when executed by a processor, implements the method for evaluating an assembly pose of an industrial part.

According to specific embodiments provided in the present disclosure, the present disclosure has the following technical effects:

The present disclosure provides a method for evaluating an assembly pose of an industrial part, a device, a medium, and a product. A multi-head self-attention mechanism of a Transformer model is adopted to perform feature fusion on visual features and geometric features to obtain fused features. Through the self-attention mechanism of the Transformer model, long-term dependency relationships between the visual and geometric features can be captured effectively, ensuring pose evaluation accuracy in complex environments. A dynamic feature weight allocation model based on a two-layer fuzzy inference algorithm is adopted to perform dynamic feature weight allocation on the visual features and the geometric features to obtain feature weights. The two-layer fuzzy inference algorithm can dynamically adjust weights of feature streams at different levels, enabling the system to automatically adapt based on environmental changes and task requirements, thereby improving the robustness and generalizability of the system. The present disclosure not only theoretically improves the pose evaluation accuracy and environmental adaptability, but also has broad application prospects in practical applications, and is particularly suitable for fields such as intelligent manufacturing, robotic assembly, and automated production.

### BRIEF DESCRIPTION OF THE DRAWINGS

To describe the technical solutions in the embodiments of the present disclosure or in the conventional technology more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a method for evaluating an assembly pose of an industrial part according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

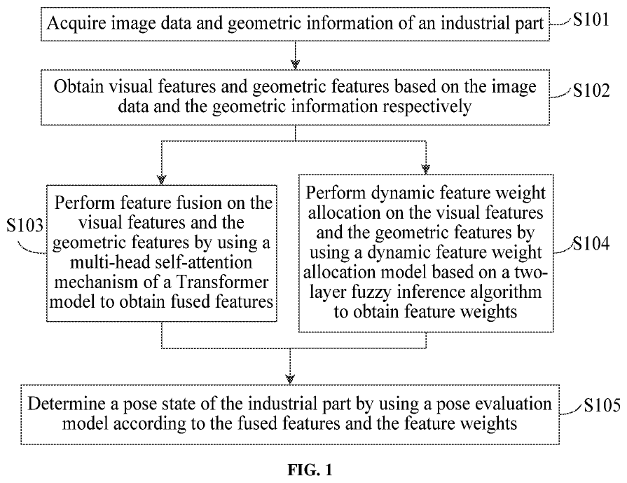

In an exemplary embodiment, as shown in FIG. 1, a method for evaluating an assembly pose of an industrial part is provided, including the following steps S101 to S105:

S101: Acquire image data and geometric information of an industrial part.

S101 specifically includes the following sub-steps.

S11: Acquire image data Iᵥᵢₛ∈ [symbol] ^{H×W×C} of the industrial part by using a vision sensor, where H and W are a height and a width of an image, and C is the number of channels of the image; the vision sensor includes, but is not limited to, a camera.

S12: Acquire geometric information P_{geo}− [symbol] ^{N×3} of the industrial part by using a depth sensor, where the geometric information is point cloud data; N is the number of point clouds, and 3 represents three-dimensional coordinates of each point. The depth sensor includes, but is not limited to, a LiDAR or a depth camera.

S102: Obtain visual features and geometric features based on the image data and the geometric information respectively.

S102 specifically includes:

S21: Extract the visual features Fᵥᵢₛ from the image data by using a convolutional neural network (CNN).

The visual features Fᵥᵢₛ are expressed as follows: Fᵥᵢₛ=CNN(Iᵥᵢₛ), where CNN represents the convolutional neural network, Fᵥᵢₛ∈ [symbol] ^{d}^{ᵥᵢₛ} represents a visual feature vector, and dᵥᵢₛ is the dimension of the feature vector.

S22: Extract the geometric features P_{geo} from the geometric information by using a point cloud processing algorithm. The point cloud processing algorithm is PointNet.

The geometric features P_{geo} are expressed as follows: F_{geo}=PointNet(P_{geo}), where F_{geo}∈ [symbol] ^{d}^{_{geo}} represents a geometric feature vector, and d_{geo} is the dimension of the feature vector.

S103: Perform feature fusion on the visual features and the geometric features by using a multi-head self-attention mechanism of a Transformer model to obtain fused features.

By setting the visual features Fᵥᵢₛ and the geometric features F_{geo} as inputs, the fused features F_{fuse} are obtained through the multi-head self-attention mechanism in the Transformer model.

In the multi-head self-attention mechanism, the Query (Q), Key (K), and Value (V) are first calculated as follows:

$$Q = {F}_{vis} {W}_{Q} , K = {F}_{geo} {W}_{K} , V = {F}_{geo} {W}_{V} ;$$

where W_{Q}, W_{K}, W_{V} are weight matrices obtained through training.

Then, a self-attention output is calculated:

$$Attention ( Q , K , V ) = soft max ( \frac{{QK}^{T}}{\sqrt{{d}_{k}}} ) V ;$$

where dₖ is the dimension of the key, and the softmax operation generates normalized attention weights. Finally, the self-attention results from a plurality of heads are combined through weighted summation to obtain the fused features F_{fuse}:

$${F}_{fuse} = Concat ( {Attention}_{1} , … , {Attention}_{h} ) {W}_{O} ;$$

where h is the number of heads, and W_{O} is an output weight matrix.

The attention mechanism can establish deep-level correlations between visual information and geometric information and dynamically adjust weights of modal features according to task requirements; it can also effectively capture long-term dependencies between visual and geometric features, thereby ensuring pose evaluation accuracy in complex environments.

S104: Perform dynamic feature weight allocation on the visual features and the geometric features by using a dynamic feature weight allocation model based on a two-layer fuzzy inference algorithm to obtain feature weights.

S104 specifically includes:
determining the feature weights by using a formula as follows: α_{final}=λ₁α₁+λ₂α₂;
where α_{final} represents the feature weights; λ₁ and λ₂ are weighting coefficients for characterizing relative importance of the two-layer fuzzy inference algorithm; α₁ represents preliminary weights of the visual features and the geometric features obtained by a first-layer fuzzy inference algorithm; α₁=f₁(E, T); f₁ is a fuzzy inference function based on an environmental condition and a task requirement, E is the environmental condition, and T is the task requirement; α₂ represents weights adjusted by a second-layer fuzzy inference algorithm; α₂=f₂(α₁, F_{feedback}); f₂ is a fuzzy inference function based on real-time feedback, and F_{feedback} is real-time feedback information.

In the first-layer fuzzy inference algorithm, preliminary feature weights are calculated using fuzzy logic based on environmental conditions and task requirements. For example, when illumination is insufficient and the industrial part is partially occluded, the weight of geometric features is increased; if the task requires rapid assembly, the weight of visual features is increased. The second-layer fuzzy inference algorithm optimizes and adjusts the preliminary feature weights based on real-time task feedback. For instance, when a feature stream performs poorly in the current task, the weight of the feature stream is reduced; if visual features help improve positioning accuracy, the weight of the visual features is enhanced. Finally, the weight results α₁ and α₂ from the first and second layers are merged through weighted summation to obtain the feature weights afiₙₐₗ. In other words, the two-layer fuzzy inference algorithms run in parallel, generating different weight allocation suggestions, respectively. The results are then merged through weighted summation or a learnable fusion network to generate the final feature weights.

S105: Determine a pose state of the industrial part by using a pose evaluation model according to the fused features and the feature weights, where the pose state includes: a position (3-dimensional) and an orientation (3-dimensional) of the industrial part.

When the pose evaluation model is a multi-layer perceptron, the pose state of the industrial part is determined using a regression method, which specifically includes:
determining the pose state of the industrial part by using a formula as follows: Pₚₒₛₑ=MLP(F_{fuse}·α_{final});
where Pₚₒₛₑ represents the pose state, MLP represents the multi-layer perceptron, α_{final} represents the feature weights, and F_{fuse} represents the fused features.

The method for evaluating an assembly pose of an industrial part in the present disclosure offers the following effects:

(1) Improved accuracy: Through the cross-modal attention mechanism of the Transformer model, visual and geometric information can be effectively fused, thereby enhancing the accuracy of part pose evaluation. This method performs particularly well in complex environments and dynamic tasks.

(2) Enhanced environmental adaptability: By using the dynamic feature weight allocation model based on the two-layer fuzzy inference algorithm, feature weights can be dynamically adjusted according to environmental changes and task requirements. This provides higher adaptability and stability in different working environments.

(3) Multi-modal information fusion: Through the deep fusion of visual and geometric information, the appearance and geometric features of industrial parts are fully explored, thereby improving the accuracy of pose evaluation.

(4) Real-time performance and robustness: The dynamic feature weight allocation model based on the two-layer fuzzy inference algorithm processes tasks in parallel and incorporates real-time feedback, enabling rapid responses to environmental and task changes. This ensures efficient execution of the method in complex and dynamic environments.

Based on the same inventive conception, an embodiment of the present disclosure further provides an apparatus for evaluating an assembly pose of an industrial part, which is used for implementing the aforementioned method for evaluating an assembly pose of an industrial part. Implementation solutions provided by the apparatus for resolving the problems are similar to the implementation solutions recorded in the method. Therefore, for specific limitations in the apparatus embodiment for evaluating an assembly pose of an industrial part provided below, reference can be made to the limitations on the method for evaluating an assembly pose of an industrial part mentioned above. Details are not described herein again.

In an exemplary embodiment, an apparatus for evaluating an assembly pose of an industrial part is provided, including:
a data acquisition module configured to acquire image data and geometric information of an industrial part;
a feature extraction module configured to obtain visual features and geometric features based on the image data and the geometric information respectively;
a multi-modal feature fusion module configured to perform feature fusion on the visual features and the geometric features by using a multi-head self-attention mechanism of a Transformer model to obtain fused features;
a dynamic feature weight allocation module configured to perform dynamic feature weight allocation on the visual features and the geometric features by using a dynamic feature weight allocation model based on a two-layer fuzzy inference algorithm to obtain feature weights; and
a pose evaluation module configured to determine a pose state of the industrial part by using a pose evaluation model according to the fused features and the feature weights, where the pose state includes: a position and an orientation of the industrial part.

In an exemplary embodiment, a computer device is provided. The computer device may be a server or a terminal. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The input/output interface of the computer apparatus is configured to exchange information between the processor and an external device. The communication interface of the computer device is configured to communicate with an external terminal through a network. When the computer program is executed by the processor, a method for evaluating an assembly pose of an industrial part is implemented.

In an embodiment, a computer-readable storage medium is provided. The computer-readable storage medium stores a computer program, and the computer program is executed by a processor to implement the steps of the above method embodiment.

In an embodiment, a computer program product is provided. The computer program product includes a computer program, and the computer program is executed by a processor to implement the steps of the above method embodiment.

It is to be noted that user information (including, but not limited to, user device information, user personal information, and the like) and data (including, but not limited to, data for analysis, data for storage, data for presentation, and the like) involved in the present disclosure are information and data authorized by the user or fully authorized by each party, and relevant data shall be collected, used, and processed according to the related regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present disclosure may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

In the present disclosure, the signals, information, or data are acquired in compliance with the relevant data protection regulations and policies of the respective country with the authorization of the respective device owner.

The technical characteristics of the above embodiments can be combined in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the above embodiments is only used to help understand the method of the present disclosure and the core principles thereof. In addition, those of ordinary skill in the art can make various modifications in terms of the specific implementations and scope of application in accordance with the teachings of the present disclosure. In conclusion, the content of the specification shall not be construed as a limitation to the present disclosure.

What is claimed is:

1. A method for evaluating an assembly pose of an industrial part, comprising:
acquiring image data and geometric information of an industrial part;
obtaining visual features and geometric features based on the image data and the geometric information respectively;
performing feature fusion on the visual features and the geometric features by using a multi-head self-attention mechanism of a Transformer model to obtain fused features;
performing dynamic feature weight allocation on the visual features and the geometric features by using a dynamic feature weight allocation model based on a two-layer fuzzy inference algorithm to obtain feature weights; and
determining a pose state of the industrial part by using a pose evaluation model according to the fused features and the feature weights, wherein the pose state comprises: a position and an orientation of the industrial part.

2. The method for evaluating an assembly pose of an industrial part according to claim 1, wherein the acquiring image data and geometric information of an industrial part comprises:
acquiring the image data of the industrial part by using a vision sensor; and
acquiring the geometric information of the industrial part by using a depth sensor.

3. The method for evaluating an assembly pose of an industrial part according to claim 1, wherein the obtaining visual features and geometric features based on the image data and the geometric information respectively comprises:
extracting the visual features from the image data by using a convolutional neural network (CNN); and
extracting the geometric features from the geometric information by using a point cloud processing algorithm.

4. The method for evaluating an assembly pose of an industrial part according to claim 1, wherein the performing dynamic feature weight allocation on the visual features and the geometric features by using the dynamic feature weight allocation model based on the two-layer fuzzy inference algorithm to obtain the feature weights comprises:
determining the feature weights by using a formula α_{final}=λ₁α₁+λ₂α₂;
wherein α_{final} represents the feature weights; λ₁ and λ₂ are weighting coefficients for characterizing relative importance of the two-layer fuzzy inference algorithm; α₁ represents preliminary weights of the visual features and the geometric features obtained by a first-layer fuzzy inference algorithm; α₁=f₁(E, T); f₁ is a fuzzy inference function based on an environmental condition and a task requirement, E is the environmental condition, and T is the task requirement; α₂ represents weights adjusted by a second-layer fuzzy inference algorithm; α₂=f₂(α₁, F_{feedback}); f₂ is a fuzzy inference function based on real-time feedback, and F_{feedback} is real-time feedback information.

5. The method for evaluating an assembly pose of an industrial part according to claim 1, wherein the pose evaluation model is a multi-layer perceptron.

6. The method for evaluating an assembly pose of an industrial part according to claim 5, wherein the determining the pose state of the industrial part by using the pose evaluation model according to the fused features and the feature weights, wherein the pose state comprises: the position and the orientation of the industrial part comprises:
determining the pose state of the industrial part by using a formula Pₚₒₛₑ=MLP(F_{fuse}·α_{final});
wherein Pₚₒₛₑ represents the pose state, MLP represents the multi-layer perceptron, α_{final} represents the feature weights, and F_{fuse} represents the fused features.

7. An apparatus for evaluating an assembly pose of an industrial part, comprising:
a data acquisition module configured to acquire image data and geometric information of an industrial part;
a feature extraction module configured to obtain visual features and geometric features based on the image data and the geometric information respectively;
a multi-modal feature fusion module configured to perform feature fusion on the visual features and the geometric features by using a multi-head self-attention mechanism of a Transformer model to obtain fused features;
a dynamic feature weight allocation module configured to perform dynamic feature weight allocation on the visual features and the geometric features by using a dynamic feature weight allocation model based on a two-layer fuzzy inference algorithm to obtain feature weights; and
a pose evaluation module configured to determine a pose state of the industrial part by using a pose evaluation model according to the fused features and the feature weights, wherein the pose state comprises: a position and an orientation of the industrial part.

8. A computer device, comprising a memory, a processor, and a computer program stored in the memory and executable on the processor, wherein the processor executes the computer program to implement the method for evaluating an assembly pose of an industrial part according to claim 1.

9. A non-transitory computer-readable storage medium, storing a computer program, wherein the computer program, when executed by a processor, implements the method for evaluating an assembly pose of an industrial part according to claim 1.

10. The computer device according to claim 8, wherein the acquiring image data and geometric information of an industrial part comprises:
acquiring the image data of the industrial part by using a vision sensor; and
acquiring the geometric information of the industrial part by using a depth sensor.

11. The computer device according to claim 8, wherein the obtaining visual features and geometric features based on the image data and the geometric information respectively comprises:
extracting the visual features from the image data by using a convolutional neural network (CNN); and
extracting the geometric features from the geometric information by using a point cloud processing algorithm.

12. The computer device according to claim 8, wherein the performing dynamic feature weight allocation on the visual features and the geometric features by using the dynamic feature weight allocation model based on the two-layer fuzzy inference algorithm to obtain the feature weights comprises:
determining the feature weights by using a formula α_{final}=λ₁α₁+λ₂α₂;
wherein α_{final} represents the feature weights; λ₁ and λ₂ are weighting coefficients for characterizing relative importance of the two-layer fuzzy inference algorithm; α₁ represents preliminary weights of the visual features and the geometric features obtained by a first-layer fuzzy inference algorithm; α₁=f₁(E, T); f₁ is a fuzzy inference function based on an environmental condition and a task requirement, E is the environmental condition, and T is the task requirement; α₂ represents weights adjusted by a second-layer fuzzy inference algorithm; α₂=f₂(α₁, F_{feedback}); f₂ is a fuzzy inference function based on real-time feedback, and F_{feedback} is real-time feedback information.

13. The computer device according to claim 8, wherein the pose evaluation model is a multi-layer perceptron.

14. The computer device according to claim 13, wherein the determining the pose state of the industrial part by using the pose evaluation model according to the fused features and the feature weights, wherein the pose state comprises: the position and the orientation of the industrial part comprises:
determining the pose state of the industrial part by using a formula Pₚₒₛₑ=MLP(F_{fuse}·α_{final});
wherein Pₚₒₛₑ represents the pose state, MLP represents the multi-layer perceptron, α_{final} represents the feature weights, and F_{fuse} represents the fused features.

15. The non-transitory computer-readable storage medium according to claim 9, wherein the acquiring image data and geometric information of an industrial part comprises:
acquiring the image data of the industrial part by using a vision sensor; and
acquiring the geometric information of the industrial part by using a depth sensor.

16. The non-transitory computer-readable storage medium according to claim 9, wherein the obtaining visual features and geometric features based on the image data and the geometric information respectively comprises:
extracting the visual features from the image data by using a convolutional neural network (CNN); and
extracting the geometric features from the geometric information by using a point cloud processing algorithm.

17. The non-transitory computer-readable storage medium according to claim 9, wherein the performing dynamic feature weight allocation on the visual features and the geometric features by using the dynamic feature weight allocation model based on the two-layer fuzzy inference algorithm to obtain the feature weights comprises:
determining the feature weights by using a formula α_{final}=λ₁α₁+λ₂α₂;
wherein α_{final} represents the feature weights; λ₁ and λ₂ are weighting coefficients for characterizing relative importance of the two-layer fuzzy inference algorithm; α₁ represents preliminary weights of the visual features and the geometric features obtained by a first-layer fuzzy inference algorithm; α₁=f₁(E, T); f₁ is a fuzzy inference function based on an environmental condition and a task requirement, E is the environmental condition, and T is the task requirement; α₂ represents weights adjusted by a second-layer fuzzy inference algorithm; α₂=f₂(α₁, F_{feedback}); f₂ is a fuzzy inference function based on real-time feedback, and F_{feedback} is real-time feedback information.

18. The non-transitory computer-readable storage medium according to claim 9, wherein the pose evaluation model is a multi-layer perceptron.

19. The non-transitory computer-readable storage medium according to claim 18, wherein the determining the pose state of the industrial part by using the pose evaluation model according to the fused features and the feature weights, wherein the pose state comprises: the position and the orientation of the industrial part comprises:
determining the pose state of the industrial part by using a formula Pₚₒₛₑ=MLP(F_{fuse}·α_{final});
wherein Pₚₒₛₑ represents the pose state, MLP represents the multi-layer perceptron, α_{final} represents the feature weights, and F_{fuse} represents the fused features.
